(19) United States
(12) Patent Application Publication
(10) Pub. No.: US 2026/0300991 A1
(43) Pub. Date: Oct. 1, 2026

(54) SYSTEM AND METHODS FOR LOCATION-BASED NEIGHBOR-TO-NEIGHBOR SHOPPING ASSISTANCE WITH AUTOMATED ROLE-SWITCHING

(71) Applicants: Rami Abousleiman, Bothell, WA (US); Sricharan Maruneni, Rochester Hills, MI (US)

(72) Inventors: Rami Abousleiman, Bothell, WA (US); Sricharan Maruneni, Rochester Hills, MI (US)

(73) Assignee: TruNeighbor LLC, Huntington Beach, CA (US)

(21) Appl. No.: 19/575,337

(22) Filed: Mar. 23, 2026

Related U.S. Application Data
(60) Provisional application No. 63/777,331, filed on Mar. 25, 2025.

(51) Int. Cl. G06Q 30/015; G06Q 20/10; H04W 4/021

(52) U.S. Cl. CPC G06Q 30/015; G06Q 20/10; H04W 4/021

(57) ABSTRACT

A system for location-based neighbor-to-neighbor shopping assistance enables real-time coordination between users, allowing those already visiting a store to assist in shopping for nearby neighbors. The system employs geofencing to detect when a registered user enters a participating retail store location and automatically transmits shopping availability notifications to designated neighbors determined based on proximity of registered home addresses. Designated neighbors may submit requests, which the shopper reviews and accepts or declines through an interactive request management interface. Upon acceptance, the system establishes an in-app communication channel between the shopper and the requesting neighbor. A dynamic role-switching mechanism automatically transitions users between shopper and requester roles based on real-time location data. The system further supports secure payment processing, request grouping, scheduled shopping notifications, selective location tracking for battery optimization, and notification blocking preferences.

### CROSS-REFERENCE TO RELATED APPLICATIONS

The present application claims priority to U.S. Provisional Application No. 63/777,331 filed Mar. 25, 2025, titled “SYSTEM AND METHODS FOR LOCATION-BASED NEIGHBOR-TO-NEIGHBOR SHOPPING ASSISTANCE WITH AUTOMATED ROLE-SWITCHING,” which is hereby incorporated by reference.

### TECHNICAL FIELD

The embodiments generally relate to systems and methods for location-based shopping assistance, and more particularly to mobile application platforms that utilize real-time geofencing and proximity-based matching to coordinate peer-to-peer shopping between neighboring users.

### BACKGROUND

Shopping often requires individuals to make separate trips to retail stores, resulting in redundant travel, increased traffic congestion, and inefficient use of time. Various delivery platforms have emerged to address these inefficiencies by connecting consumers with shopping and delivery services. These platforms generally rely on dedicated shoppers or third-party couriers who are dispatched to retail locations specifically to fulfill customer orders. While such platforms provide convenience, they introduce additional operational costs associated with maintaining a workforce of dedicated shoppers, and the logistics of routing those shoppers to stores and then to delivery destinations can be complex and resource-intensive.

Some peer-to-peer service platforms have explored community-based models in which individuals assist one another with errands or shopping tasks. These platforms typically require users to manually post requests or browse available tasks, and coordination between parties depends on active user engagement rather than automated processes. Location-based features in such platforms, where present, tend to operate on broad geographic parameters and do not account for established neighborhood relationships or the natural shopping patterns of individual users. As a result, matching between those who need items and those who are already visiting a store can be imprecise or untimely.

Existing systems also generally assign fixed roles to participants, designating certain users permanently as shoppers or delivery personnel and others as customers. This static role structure limits participation flexibility and does not take advantage of the fact that any given user may visit a retail store on a particular day and be in a position to assist others, while on a different day that same user may benefit from assistance. Current platforms lack mechanisms to dynamically coordinate shopping activities based on real-time proximity to retail locations within a defined neighborhood context.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

In one aspect, the present disclosure provides a system for location-based neighbor-to-neighbor shopping assistance. The system includes at least one user computing device having a location-tracking module and an application server configured to host an application program for coordinating shopping between users. The application server maintains a store geofence database storing predefined geofence boundaries associated with participating retail store locations and a neighbor registry database that associates each registered user with a registered home address and identifies a set of designated neighbors based on proximity of registered home addresses within a predefined geographic radius. By anchoring neighbor relationships to registered home addresses rather than transient physical locations, the system establishes a stable, community-based network that reflects actual neighborhood connections.

When the application server determines, based on location data received from a user computing device, that a first user has entered a predefined store geofence associated with a participating retail store location, the system automatically transmits a shopping availability notification to user computing devices associated with the designated neighbors of the first user. This automated, geofence-triggered notification mechanism addresses the limitations of platforms that rely on manual posting or browsing by ensuring that neighbors are promptly informed when a nearby community member is already present at a store and available to assist with shopping. Designated neighbors may then submit requests specifying requested items, and the first user may accept or decline each request through an interactive request management interface. Upon acceptance, the system establishes an in-app communication channel between the shopper and the requesting neighbor to facilitate real-time coordination regarding the requested items.

The system further introduces a dynamic role-switching mechanism that automatically transitions users between shopper and requester roles based on real-time location data. A user who acts as a requester in one transaction is automatically designated as a shopper when the system detects that the user has entered a predefined store geofence on a subsequent occasion. This bidirectional role structure overcomes the static role assignments found in conventional platforms by enabling any user to serve as either a shopper or a requester depending on their natural shopping activity, thereby leveraging existing store visits rather than requiring dedicated shopping personnel.

In another aspect, the present disclosure provides a computer-implemented method for location-based neighbor-to-neighbor shopping assistance that includes registering users with associated home addresses, determining designated neighbor sets based on home address proximity, monitoring location data, detecting store geofence entry, automatically transmitting shopping availability notifications, receiving and managing requests, establishing in-app communication channels, and dynamically switching role assignments between shopper and requester roles. In yet another aspect, the present disclosure provides a non-transitory computer-readable storage medium storing computer-executable instructions that, when executed by one or more processors, cause a computing system to perform these operations.

Additional features of the disclosed embodiments include selective location tracking that activates high-frequency position monitoring only within or proximate to store geofences to conserve battery power and reduce server load, secure payment processing that calculates service fees and platform commissions, a scheduled shopping mode that allows users to announce planned store visits in advance, request grouping that aggregates multiple neighbor requests into a consolidated task list for efficient retrieval, and a blocking mechanism that enables users to selectively suppress notifications from specified shoppers, stores, or store chains.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram of a location-based neighbor-to-neighbor shopping assistance system, according to some embodiments.

FIG. 2 illustrates a block diagram of the application server and the functional modules of the application program, according to some embodiments.

FIG. 3 illustrates a flowchart of a method for coordinating neighbor-to-neighbor shopping assistance from geofence detection through request fulfillment and payment processing, according to some embodiments.

FIG. 4 illustrates a flowchart of a method for dynamic role-switching between shopper and requester designations based on store geofence entry and exit detection, according to some embodiments.

FIG. 5 illustrates a flowchart of a method for the end-to-end shopping assistance workflow including location monitoring, geofence entry detection, neighbor identification, notification transmission, request handling, communication channel establishment, request fulfillment, payment processing, and role updating, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The embodiments disclosed herein relate to systems and methods for coordinating neighbor-to-neighbor shopping assistance, specifically utilizing geolocation-based matching and automated notifications. The system may include a mobile application and/or web-based platform that enables users to coordinate shopping trips in real time, reducing redundant store visits and fostering community-driven shopping collaboration. During use, the system provides a platform for shoppers and requesters to interact, submit requests, and track order fulfillment. The system integrates with location-based services and geofencing technology to provide seamless, real-time notifications when a neighbor enters a participating store. The system enables users to switch between shopper and requester roles dynamically, while also allowing requesters to track their order status and coordinate deliveries efficiently.

The system may be implemented across a computing environment that includes one or more user computing devices, an application server, and a network connecting them. Each user computing device may be a smartphone, tablet, laptop, desktop computer, or other mobile or stationary computing device capable of running a software application and communicating over a network. Each user computing device includes one or more processors coupled to a memory, one or more input/output devices such as a display and a touchscreen interface, a network interface for communicating with the application server, and a location-tracking module. The location-tracking module may determine the geographic position of the user computing device using one or more positioning technologies, including but not limited to Global Positioning System (GPS) receivers, assisted GPS, Wi-Fi-based positioning, cellular network triangulation, Bluetooth beacons, or any combination thereof. The location-tracking module generates location data representing the current geographic coordinates of the user computing device and transmits this location data to the application server via the network at periodic intervals or in response to triggering events.

The application server may be a standalone server, a distributed server system, or a cloud-based computing environment. The application server includes one or more processors coupled to a memory and a network interface for communicating with the user computing devices over the network. The network may be a local area network, a wide area network, the Internet, a cellular data network, or any combination thereof. The application server hosts an application program that coordinates shopping between users. The application program may be implemented using any suitable programming language, scripting language, or combination thereof, and may execute on the application server, on the user computing devices, or partly on both. The memory of the application server stores computer-readable application instructions configured to implement the embodiments described herein, along with one or more databases accessible by the application instructions.

The application program operates through several functional modules that collectively enable the neighbor-to-neighbor shopping assistance workflow. These modules include a geofence detection module, a neighbor registry module, a notification module, a request management module, a role-switching module, a communication module, and a payment processing module. Each module may be implemented as a software component, a microservice, a set of functions within a monolithic application, or any other suitable software architecture. The modules communicate with one another and with the databases maintained by the application server to perform the operations described herein.

The application server maintains a store geofence database that stores predefined geofence boundaries associated with one or more participating retail store locations. Each geofence boundary defines a virtual perimeter around a physical retail store location and may be represented as a set of geographic coordinates forming a polygon, a center point with an associated radius, or any other suitable geometric representation. The geofence boundaries may be configured by an administrator of the system, derived from publicly available geographic data associated with retail store locations, or established through partnerships with retail store operators. The store geofence database may store additional metadata for each participating retail store location, such as the store name, the retail chain with which the store is affiliated, the store address, operating hours, and categories of goods available at the store. The geofence detection module of the application program accesses the store geofence database and compares incoming location data from user computing devices against the stored geofence boundaries to determine whether a user has entered, remains within, or has exited a particular store geofence.

The application server also maintains a neighbor registry database that associates each registered user with a registered home address and identifies, for each registered user, a set of designated neighbors. The neighbor registry database may store user profile information including the user's name, registered home address, payment details, notification preferences, preferred stores, and availability settings. The set of designated neighbors for a given user is determined based on proximity of the registered home addresses of the plurality of registered users within a predefined geographic radius. The predefined geographic radius may be a configurable parameter, and in some embodiments the radius may be set at approximately three miles or another distance deemed reasonable for neighborhood-based shopping assistance. The neighbor determination is based solely on the proximity of registered home addresses and is independent of the current physical location of any user. This means that when a user visits a participating retail store location that is geographically remote from the user's registered home address, such as a store near the user's workplace in a different city, the system transmits shopping availability notifications only to the designated neighbors associated with the user's registered home address, rather than to users who happen to be physically near the store but are not part of the user's home neighborhood. This approach ensures that the system facilitates shopping assistance specifically within established home-based communities.

The system includes a user interface that allows users to create an account and input personal information such as name, address, and payment details. Users may also add preferred stores to their profile, set notification preferences, and define their availability for shopping assistance. Once a user's account is set up, the platform may automatically detect store visits through geofencing and send notifications to nearby neighbors, enabling them to submit shopping requests. The user interface may be implemented as a graphical user interface rendered on the display of the user computing device, and may include standard interface elements such as buttons, text fields, scrollable lists, map views, and notification panels.

The geofence detection module receives location data from the location-tracking modules of user computing devices and determines, based on the received location data and the geofence boundaries stored in the store geofence database, whether a user has entered a predefined store geofence. The geofence detection module may perform this determination by computing whether the geographic coordinates reported by the user computing device fall within the boundary defined for a participating retail store location. In some embodiments, the geofence detection module confirms entry when the location data indicates that the user is within the predefined geofence boundary for a threshold duration, such as thirty seconds or one minute, to reduce false positives that might occur when a user merely passes near a store without entering it. The geofence detection module may also detect when a user exits a store geofence, which may trigger status updates or reset the availability of the user for subsequent shopping sessions. When the geofence detection module determines that a user has exited a store geofence or when a configurable timer expires, the system may reset the user's shopper status and cease transmitting notifications to designated neighbors regarding that particular store visit.

The location-tracking module of the user computing device may implement selective location tracking to conserve battery power and reduce server load. Under this approach, the location-tracking module operates in a low-frequency monitoring mode when the user computing device is outside all predefined store geofences, transmitting location data to the application server at relatively infrequent intervals, such as every few minutes. When the location data indicates that the user computing device is within or proximate to a predefined store geofence, the location-tracking module transitions to a high-frequency monitoring mode, transmitting location data at more frequent intervals, such as every few seconds, to enable precise geofence entry and exit detection. This selective approach reduces the computational and power demands on the user computing device and minimizes the volume of location data transmitted to and processed by the application server, while still providing sufficient precision for geofence-based triggering of notifications.

The notification module is responsible for generating and transmitting shopping availability notifications in response to geofence entry events detected by the geofence detection module. When the geofence detection module determines that a first user has entered a predefined store geofence associated with a participating retail store location, the notification module queries the neighbor registry database to retrieve the set of designated neighbors associated with the first user. The notification module then automatically transmits a shopping availability notification to the user computing devices associated with each designated neighbor. The shopping availability notification may identify the participating retail store location by name, address, or retail chain, and may offer the designated neighbors an opportunity to submit requests. The notification may be delivered as a push notification, an in-app alert, a text message, or any other suitable notification mechanism supported by the user computing device. The notification is transmitted exclusively to user computing devices associated with designated neighbors determined based on proximity of registered home addresses, such that users who are physically near the participating retail store location but are not designated neighbors of the first user based on home address proximity do not receive the notification.

The notification module also supports a scheduled shopping mode. In this mode, a user may manually select a participating retail store location and specify an estimated arrival time for a planned future visit. Upon receiving this scheduled shopping indication, the notification module transmits a pre-arrival shopping availability notification to the user computing devices associated with the set of designated neighbors of the user. The pre-arrival notification identifies the selected participating retail store location and the estimated arrival time, allowing designated neighbors to prepare and submit requests in advance of the user's arrival at the store. This scheduled mode provides an alternative to the automated geofence-triggered notification pathway and may be useful when a user wishes to solicit requests from neighbors before departing for the store.

The request management module processes requests submitted by designated neighbors in response to shopping availability notifications. A designated neighbor who receives a notification may open the application on their user computing device and submit a request specifying one or more requested items. Each request may include item descriptions, quantities, preferred brands, acceptable substitutions, and any other relevant details. The request management module receives the request and presents it to the first user, who is currently at the participating retail store location, via an interactive request management interface rendered on the first user's computing device. The interactive request management interface displays incoming requests from one or more designated neighbors and provides controls enabling the first user to accept or decline each request based on convenience, feasibility, or personal preference.

The request management module may also aggregate multiple requests received from a plurality of designated neighbors into a consolidated task list. The consolidated task list may be presented to the first user via the interactive request management interface and organized to group requested items by category, aisle, or other logical grouping to facilitate efficient retrieval within the store. This request grouping functionality reduces the time and effort required for the shopper to locate and collect all requested items, and may minimize redundant trips through the same sections of the store. Upon acceptance of a request, the requested items may be added to the shopper's task list, and the request management module may track fulfillment status of each requested item in real time, updating the status as items are collected, marking items as unavailable if they cannot be found, and recording completion when all items in a request have been fulfilled.

The communication module establishes an in-app communication channel between the shopper and each designated neighbor whose request has been accepted. The communication channel may support text-based messaging, image sharing, or other forms of real-time communication. The communication channel allows the requesting neighbor to clarify item details, specify preferences, approve substitutions, or provide additional instructions to the shopper while the shopper is still at the store. Each communication channel may be unique to a particular shopper-neighbor pair for a given shopping session, ensuring that conversations remain organized and that messages are directed to the appropriate parties. The communication module may maintain a history of messages exchanged within each communication channel for reference during and after the shopping session.

The role-switching module dynamically switches role assignments for each user between a shopper role and a requester role based on real-time location data. The role-switching module monitors geofence entry events detected by the geofence detection module and updates the role designation of each user accordingly. When the system detects that a user has entered a predefined store geofence, the role-switching module designates that user as a shopper and initiates the notification workflow described above. When the same user is not within any store geofence and receives a shopping availability notification from a designated neighbor who has entered a store, that user may act as a requester by submitting a request. This dynamic role assignment ensures that a user who was designated as a requester in a first transaction may be automatically designated as a shopper in a subsequent transaction upon the system detecting that the user has entered a predefined store geofence, and vice versa. The role-switching module does not require users to manually select or change their role; instead, the transition occurs automatically based on the user's real-time physical proximity to participating retail store locations. This bidirectional role structure allows any registered user to serve as both a shopper and a requester over time, reflecting the natural variability in users' shopping patterns.

The payment processing module processes secure payment transactions between the requesting neighbor and the shopper for completed requests. Upon completion of a request, the payment processing module may calculate the total cost of the one or more requested items, a service fee payable to the shopper for fulfilling the request, and a platform commission retained by the application server to sustain platform operations. The service fee may be a fixed amount per request, a percentage of the total item cost, or a combination thereof. The platform commission may similarly be a fixed amount or a percentage of the transaction. The payment processing module may interface with one or more third-party payment service providers to facilitate secure transfer of funds between the requesting neighbor's payment account and the shopper's payment account. The payment processing module may also generate transaction records and receipts accessible to both parties through the application.

The interactive request management interface further provides a blocking feature that enables a designated neighbor to selectively suppress notifications. A user may use the blocking feature to block notifications from a specific shopper, such that the user will not receive shopping availability notifications when that particular shopper enters a store. A user may alternatively block notifications associated with a specific retail store location, such that the user will not receive notifications triggered by any shopper visiting that particular store. A user may also block notifications associated with an entire retail store chain, suppressing all notifications from any store affiliated with that chain. The blocking preferences may be stored in the user's profile within the neighbor registry database and applied by the notification module when determining which designated neighbors should receive a given shopping availability notification.

The system may support multiple neighborhood zones, enabling users to participate in different shopping communities based on their home or work location. In some embodiments, a user may register multiple addresses, such as a home address and a work address, and the system may maintain separate sets of designated neighbors for each registered address. The system may organize requests based on store visits and optimize grouping to minimize redundant trips within neighborhoods. Integrated payment processing may ensure secure and efficient transactions between shoppers and requesters while maintaining transparency and accountability.

The system may be deployed on cloud computing infrastructure or any other suitable cloud environment. In a cloud deployment, the application server, databases, and associated services may be hosted on virtual machines, containers, or serverless computing platforms that provide scalable computing resources. The system may employ load balancing, auto-scaling, and geographic distribution to handle varying numbers of concurrent users and to minimize latency for location-based operations. The databases, including the store geofence database and the neighbor registry database, may be implemented using relational database management systems, NoSQL databases, in-memory data stores, or any combination thereof suitable for the data access patterns of the application.

The user computing devices may communicate with the application server using standard network protocols, including but not limited to Hypertext Transfer Protocol Secure (HTTPS), WebSocket, or other protocols suitable for real-time data exchange. Push notifications may be delivered through platform-specific notification services, such as Apple Push Notification Service for iOS devices or Firebase Cloud Messaging for Android devices. The application program on the user computing device may be implemented as a native mobile application, a hybrid application, a progressive web application, or any other suitable application format.

Various implementations of the invention involve the technical field of real-time geofencing and proximity-based matching including registering, by an application server, a plurality of users, each user associated with a registered home address and a user computing device having a location-tracking module; determining, by the application server, for each registered user, a set of designated neighbors based on proximity of the registered home addresses of the plurality of users within a predefined geographic radius; monitoring, by the application server, location data received from the location-tracking modules of the user computing devices of the plurality of users; detecting, by the application server, based on the monitored location data and a store geofence database storing predefined geofence boundaries for participating retail store locations, that a first user has entered a predefined store geofence associated with a first participating retail store location; in response to detecting that the first user has entered the predefined store geofence, automatically transmitting, by the application server, a shopping availability notification to user computing devices associated with the set of designated neighbors of the first user, the shopping availability notification identifying the first participating retail store location; receiving, by the application server from a second user who is a designated neighbor of the first user, a request specifying one or more requested items; presenting, by the application server, the request to the first user via an interactive request management interface on the user computing device of the first user; receiving, by the application server, an acceptance of the request from the first user; establishing, by the application server, an in-app communication channel between the first user and the second user to facilitate coordination regarding the one or more requested items; and automatically switching, by the application server, role assignments for the first user and the second user, such that the second user is designated as a shopper when the application server detects that the second user has subsequently entered a predefined store geofence associated with a participating retail store location, and the first user is designated as a potential requester eligible to receive a shopping availability notification from the second user, and are therefore necessarily rooted in computer technology. For example, the aforementioned steps are inherently computer-based and cannot be performed in the human mind.

The present invention amounts to more than merely implementing the generic computer as a tool to gather, analyze, and output data because the steps of the present method, system, or product improve the field of real-time geofencing and proximity-based matching by implementing a self-organizing, geofence-triggered automation layer that operates without manual user initiation. Conventional systems either dispatch dedicated shoppers to fulfill orders or require users to manually post and browse shopping requests, both of which depend on deliberate human coordination to match supply with demand. The disclosed system, by contrast, uses a geofence detection module that continuously compares real-time location data from user computing devices against a store geofence database to automatically detect when a registered user has entered a participating retail store, and in response triggers a notification pipeline that queries a neighbor registry database, filters recipients based on home-address proximity rather than physical proximity, and transmits targeted push notifications, all without any manual action by the shopper. The role-switching module further automates the transition of each user's designation between shopper and requester roles based on geofence entry events, eliminating the need for users to manually select or toggle their status. Additionally, the selective location-tracking mechanism represents a specific technical improvement to how mobile devices manage power and data transmission, activating high-frequency GPS monitoring only when a device is proximate to a store geofence and reducing monitoring frequency otherwise, which directly addresses the technical problem of battery drain and server load in location-aware mobile systems. Taken together, these components form an integrated technical architecture, illustrated in the system block diagram and workflow flowcharts, in which the geofence detection module, neighbor registry module, notification module, request management module, role-switching module, communication module, and payment processing module interact through automated data flows to produce a functioning, self-organizing shopping network that could not operate through human coordination alone. Additionally, the steps of the present invention would be impossible to accomplish on pen and paper due to the volume of data being communicated and received over a network in real-time. In particular, the speed at which the steps of the present invention occur to effectuate the disclosed method, system, or product would involve large-scale, continuous wireless communication of such data. That is, the steps of the present method, system, or product are impossible to accomplish on pen and paper, cannot be accomplished as a method of organizing human activity, and amount to significantly more than merely gathering, analyzing, and outputting data.

Implementations of the present invention include implementing (executing, running, or deploying) one or more artificial intelligence models on a computing device wherein the computing device executes the artificial intelligence model's algorithms and mathematical functions on computer hardware using machine learning libraries. The computing device implements the artificial intelligence model when it performs tasks like training, making predictions, applying the model to data, decision-making, classification, or generating outputs based on inputs. In particular, the speed at which an artificial intelligence model analyzes and transforms data to effectuate the disclosed method, system, or product would involve large-scale, continuous transformation of such data. As such, the present invention would be impossible to accomplish on pen and paper or in the human mind due to the volume of data being analyzed and transformed by the artificial intelligence model.

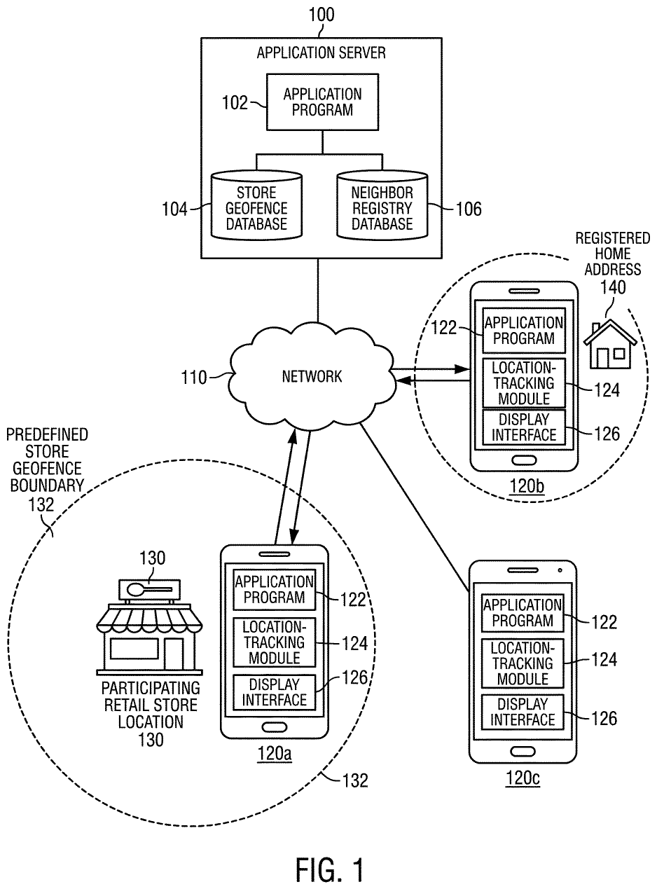

FIG. 1 illustrates a system architecture diagram of a location-based neighbor-to-neighbor shopping assistance system, according to some embodiments. The system architecture depicted in FIG. 1 includes an application server 100, a network 110, a plurality of user computing devices 120a, 120b, and 120c, a participating retail store location 130, a predefined store geofence boundary 132, and a registered home address 140. These components interact to enable automated, geofence-triggered coordination of shopping between neighboring users.

The application server 100 is positioned at the top of FIG. 1 and represents the central computing infrastructure that hosts the application program 102 and maintains the data stores used to coordinate shopping activities among registered users. The application server 100 may be implemented as a standalone server, a distributed server system, or a cloud-based computing environment comprising one or more processors coupled to a memory. The application server 100 communicates with the plurality of user computing devices 120a, 120b, and 120c via the network 110.

The application program 102 resides within the application server 100 and contains the executable software instructions that implement the neighbor-to-neighbor shopping assistance workflow. The application program 102 coordinates all operations performed by the system, including monitoring location data received from user computing devices, detecting geofence entry and exit events, determining designated neighbor sets, generating and transmitting notifications, managing requests, facilitating in-app communication, processing payment transactions, and dynamically switching user role assignments between shopper and requester designations. The application program 102 communicates with and accesses the store geofence database 104 and the neighbor registry database 106 to perform these operations.

The store geofence database 104 is depicted within the application server 100 and stores predefined geofence boundaries associated with one or more participating retail store locations. Each entry in the store geofence database 104 may include a set of geographic coordinates defining a virtual perimeter around a physical retail store, along with metadata such as the store name, retail chain affiliation, store address, operating hours, and categories of goods available. The application program 102 accesses the store geofence database 104 to compare incoming location data from user computing devices against the stored geofence boundaries, thereby determining whether a user has entered, remains within, or has exited a predefined store geofence boundary 132 associated with a participating retail store location 130.

The neighbor registry database 106 is also depicted within the application server 100 and stores user profile information for each registered user, including the user's name, registered home address, payment details, notification preferences, preferred stores, and availability settings. The neighbor registry database 106 further stores, for each registered user, a set of designated neighbors determined based on proximity of the respective registered home addresses of the plurality of registered users within a predefined geographic radius. The neighbor determination is based solely on the proximity of registered home addresses and is independent of the current physical location of any user. When the application program 102 detects that a user has entered a store geofence, the application program 102 queries the neighbor registry database 106 to retrieve the set of designated neighbors associated with that user and to determine which user computing devices should receive a shopping availability notification.

The network 110 is depicted in the center of FIG. 1 and represents the communication infrastructure connecting the application server 100 to the plurality of user computing devices 120a, 120b, and 120c. The network 110 may be a local area network, a wide area network, the Internet, a cellular data network, a Wi-Fi network, or any combination thereof. The network 110 facilitates the transmission of location data from the user computing devices to the application server 100, the delivery of shopping availability notifications from the application server 100 to the user computing devices, the exchange of requests and acceptance or declination responses, in-app communication messages between shoppers and requesters, and payment transaction data.

The user computing devices 120a, 120b, and 120c are depicted in FIG. 1 and represent the mobile or stationary computing devices operated by registered users of the system. Each user computing device 120a, 120b, and 120c may be a smartphone, tablet, laptop, or other computing device capable of running the application program 122 and communicating with the application server 100 via the network 110. Each user computing device includes an instance of the application program 122, a location-tracking module 124, and a display interface 126.

The application program 122 is a client-side software application installed on each user computing device 120a, 120b, and 120c. The application program 122 communicates with the application program 102 hosted on the application server 100 to transmit location data, receive shopping availability notifications, submit and receive requests, exchange in-app communication messages, and process payment transactions. The application program 122 renders the interactive request management interface, the communication channel interface, and other user-facing screens on the display interface 126 of the respective user computing device.

The location-tracking module 124 is a component of each user computing device 120a, 120b, and 120c and is configured to determine the geographic position of the user computing device using one or more positioning technologies, including but not limited to Global Positioning System (GPS) receivers, assisted GPS, Wi-Fi-based positioning, cellular network triangulation, Bluetooth beacons, or any combination thereof. The location-tracking module 124 generates location data representing the current geographic coordinates of the user computing device and transmits this location data to the application server 100 via the network 110 at periodic intervals or in response to triggering events. The location-tracking module 124 may implement selective location tracking, operating in a low-frequency monitoring mode when the user computing device is outside all predefined store geofences and transitioning to a high-frequency monitoring mode when the user computing device is within or proximate to a predefined store geofence boundary 132, thereby conserving battery power and reducing server load.

The display interface 126 is a component of each user computing device 120a, 120b, and 120c and provides the visual output through which users interact with the application program 122. The display interface 126 may be a touchscreen display, an external monitor, or any other suitable display device. The display interface 126 renders the graphical user interface of the application program 122, including notification panels, the interactive request management interface for reviewing and accepting or declining requests, the in-app communication channel for exchanging messages with shoppers or requesters, item request forms, task lists, and payment confirmation screens.

In the scenario depicted in FIG. 1, user computing device 120a is shown positioned within the predefined store geofence boundary 132 at the participating retail store location 130. The participating retail store location 130 represents a physical retail store, such as a store, supermarket, or other retail establishment, whose geofence boundary is stored in the store geofence database 104. The predefined store geofence boundary 132 is represented as a dashed circular perimeter surrounding the participating retail store location 130 and defines the virtual boundary within which the application server 100 recognizes that a user has entered the store. When the location-tracking module 124 of user computing device 120a reports location data indicating that user computing device 120a is within the predefined store geofence boundary 132, the application program 102 on the application server 100 detects the geofence entry event and initiates the notification workflow.

User computing device 120b is shown positioned near the registered home address 140, which is depicted as a house icon on the right side of FIG. 1. The registered home address 140 represents the home address that the user of user computing device 120b provided during registration and that is stored in the neighbor registry database 106. The proximity of this registered home address 140 to the registered home addresses of other users determines the set of designated neighbors for the user of user computing device 120b. When the application server 100 detects that the user of user computing device 120a has entered the predefined store geofence boundary 132, the application server 100 queries the neighbor registry database 106 and determines that the user of user computing device 120b is a designated neighbor of the user of user computing device 120a based on the proximity of their respective registered home addresses. The application server 100 then transmits a shopping availability notification to user computing device 120b via the network 110.

User computing device 120c is depicted in the lower right area of FIG. 1 and represents another user computing device operated by a registered user. User computing device 120c includes the same components as user computing devices 120a and 120b, namely the application program 122, the location-tracking module 124, and the display interface 126. User computing device 120c may represent another designated neighbor of the user of user computing device 120a, or may represent a user who is not within the designated neighbor set, depending on the proximity of the respective registered home addresses stored in the neighbor registry database 106. If user computing device 120c belongs to a designated neighbor, that user also receives the shopping availability notification; if not, that user does not receive the notification regardless of the user's current physical location.

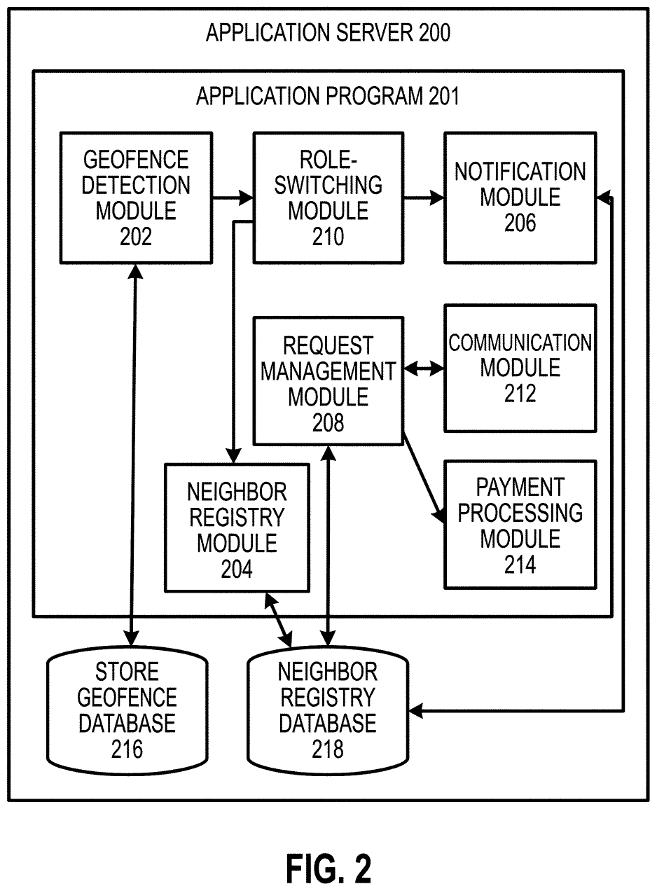

FIG. 2 illustrates a block diagram of the application server 200 and the functional modules of the application program 201, according to some embodiments. The application server 200 corresponds to the application server 100 described in connection with FIG. 1 and provides additional detail regarding the internal architecture of the application program and the functional modules that collectively enable the neighbor-to-neighbor shopping assistance workflow.

The application server 200 hosts the application program 201, which contains six functional modules and interfaces with two databases. The six functional modules are the geofence detection module 202, the neighbor registry module 204, the notification module 206, the request management module 208, the role-switching module 210, and the communication module 212. The application program 201 also includes a payment processing module 214. The two databases are the store geofence database 216 and the neighbor registry database 218, which correspond to the store geofence database 104 and the neighbor registry database 106 described in connection with FIG. 1, respectively.

The geofence detection module 202 is depicted in the upper left area of FIG. 2 and is responsible for receiving location data from the location-tracking modules 124 of user computing devices 120a, 120b, and 120c and determining whether a user has entered, remains within, or has exited a predefined store geofence boundary. The geofence detection module 202 accesses the store geofence database 216 to retrieve the predefined geofence boundaries associated with participating retail store locations and compares the incoming location data against these boundaries. When the geofence detection module 202 determines that a user's location data falls within a predefined store geofence boundary, it generates a geofence entry event. The geofence detection module 202 may confirm entry by verifying that the user remains within the geofence boundary for a threshold duration to reduce false positives. The geofence detection module 202 also detects when a user exits a store geofence, generating a geofence exit event that may trigger status updates or role transitions. The geofence detection module 202 communicates geofence entry and exit events to the role-switching module 210, as indicated by the bidirectional arrow connecting the geofence detection module 202 and the role-switching module 210 in FIG. 2.

The neighbor registry module 204 is depicted in the lower left area of FIG. 2 and is responsible for managing user registrations, maintaining user profile information, and determining the set of designated neighbors for each registered user. The neighbor registry module 204 accesses and updates the neighbor registry database 218, as indicated by the bidirectional arrow connecting the neighbor registry module 204 and the neighbor registry database 218 in FIG. 2. When a new user registers, the neighbor registry module 204 stores the user's profile information, including the registered home address, and computes the set of designated neighbors by identifying other registered users whose registered home addresses fall within a predefined geographic radius of the new user's registered home address. The neighbor registry module 204 may update the designated neighbor sets when users are added or removed from the system, or when registered home addresses change. The neighbor registry module 204 provides designated neighbor information to the notification module 206 and the request management module 208, as indicated by the arrows connecting these modules in FIG. 2.

The notification module 206 is depicted in the upper right area of FIG. 2 and is responsible for generating and transmitting shopping availability notifications to user computing devices associated with designated neighbors in response to geofence entry events. When the role-switching module 210 signals that a user has been designated as a shopper following a geofence entry event, the notification module 206 queries the neighbor registry module 204 to retrieve the set of designated neighbors for that user. The notification module 206 then generates a shopping availability notification identifying the participating retail store location and transmits the notification to the user computing devices of the designated neighbors via the network 110. The notification may be delivered as a push notification, an in-app alert, a text message, or any other suitable notification mechanism. The notification module 206 applies any blocking preferences stored in the neighbor registry database 218 to filter out designated neighbors who have blocked the shopper, the store, or the store chain, ensuring that suppressed users do not receive the notification. The notification module 206 also supports a scheduled shopping mode, in which it transmits a pre-arrival shopping availability notification in response to a user-submitted scheduled shopping indication specifying a selected store and an estimated arrival time. The notification module 206 receives input from the role-switching module 210, as indicated by the arrow from the role-switching module 210 to the notification module 206 in FIG. 2.

The request management module 208 is depicted in the center of FIG. 2 and is responsible for processing requests submitted by designated neighbors in response to shopping availability notifications. When a designated neighbor submits a request specifying one or more requested items through the application program 122 on their user computing device, the request management module 208 receives the request and presents it to the shopper via the interactive request management interface rendered on the shopper's user computing device. The interactive request management interface displays incoming requests from one or more designated neighbors and provides controls enabling the shopper to accept or decline each request. The request management module 208 may aggregate multiple requests from a plurality of designated neighbors into a consolidated task list organized to group requested items for efficient retrieval within the store. Upon acceptance of a request, the request management module 208 adds the requested items to the shopper's task list and tracks fulfillment status of each requested item in real time. The request management module 208 communicates with the communication module 212 to establish in-app communication channels upon request acceptance, as indicated by the bidirectional arrow connecting the request management module 208 and the communication module 212 in FIG. 2. The request management module 208 also communicates with the neighbor registry module 204, as indicated by the arrow connecting them, to access user profile information and designated neighbor data relevant to incoming requests.

The role-switching module 210 is depicted in the upper center area of FIG. 2 and is responsible for dynamically switching role assignments for each user between a shopper role and a requester role based on real-time location data. The role-switching module 210 receives geofence entry and exit events from the geofence detection module 202, as indicated by the bidirectional arrow between these modules. When the role-switching module 210 receives a geofence entry event indicating that a user has entered a predefined store geofence, the role-switching module 210 designates that user as a shopper and signals the notification module 206 to initiate the notification workflow, as indicated by the arrow from the role-switching module 210 to the notification module 206. When the role-switching module 210 receives a geofence exit event indicating that the user has exited the store geofence, or when a configurable timer expires, the role-switching module 210 transitions the user's designation back to a requester role, enabling the user to receive shopping availability notifications from other designated neighbors who subsequently enter a store geofence. This dynamic role-switching mechanism ensures that users automatically alternate between shopper and requester roles based on their real-time physical proximity to participating retail store locations, without requiring manual role selection.

The communication module 212 is depicted in the right center area of FIG. 2 and is responsible for establishing and maintaining in-app communication channels between shoppers and requesters. When the request management module 208 processes an accepted request, the communication module 212 establishes a unique in-app communication channel between the shopper and the designated neighbor whose request was accepted. The communication channel may support text-based messaging, image sharing, and other forms of real-time communication, allowing the requesting neighbor to clarify item details, specify preferences, approve substitutions, or provide additional instructions to the shopper while the shopper is at the store. Each communication channel is unique to a particular shopper-neighbor pair for a given shopping session. The communication module 212 receives signals from the request management module 208, as indicated by the bidirectional arrow connecting these modules in FIG. 2.

The payment processing module 214 is depicted in the lower right area of FIG. 2 and is responsible for processing secure payment transactions between requesters and shoppers upon completion of requests. The payment processing module 214 calculates the total cost of the requested items, a service fee payable to the shopper, and a platform commission retained by the application server 200. The payment processing module 214 may interface with one or more third-party payment service providers to facilitate secure transfer of funds between the requester's payment account and the shopper's payment account. The payment processing module 214 may also generate transaction records and receipts accessible to both parties through the application program 122. The payment processing module 214 communicates with the request management module 208 and the neighbor registry database 218 to access transaction details and user payment information, as indicated by the connections shown in FIG. 2.

The store geofence database 216 is depicted in the lower left area of FIG. 2 and stores the predefined geofence boundaries associated with participating retail store locations. The store geofence database 216 corresponds to the store geofence database 104 described in connection with FIG. 1. The geofence detection module 202 and the neighbor registry module 204 access the store geofence database 216, as indicated by the arrows connecting them in FIG. 2.

The neighbor registry database 218 is depicted in the lower center area of FIG. 2 and stores user profile information and designated neighbor sets for each registered user. The neighbor registry database 218 corresponds to the neighbor registry database 106 described in connection with FIG. 1. The neighbor registry module 204 accesses and updates the neighbor registry database 218, and other modules may query the neighbor registry database 218 through the neighbor registry module 204 to retrieve user and neighbor information as needed during the shopping assistance workflow.

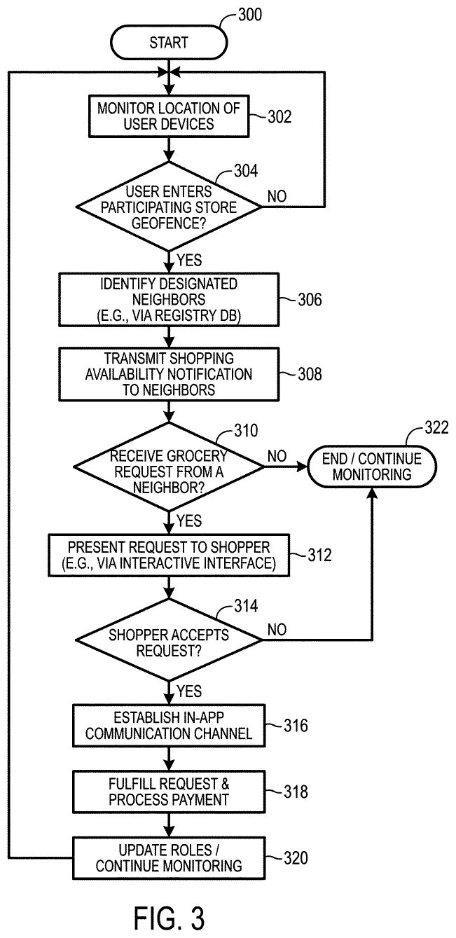

FIG. 3 illustrates a flowchart of a method 300 for coordinating neighbor-to-neighbor shopping assistance from geofence detection through request fulfillment and payment processing, according to some embodiments. The method 300 may be performed by the application program 102 executing on the application server 100 in cooperation with the application programs 122 executing on user computing devices 120a, 120b, and 120c.

The method 300 begins at a start step and proceeds to step 302, in which the application server monitors location data received from the location-tracking modules 124 of user computing devices associated with registered users. The application server continuously or periodically receives location data transmitted by the user computing devices via the network 110, enabling the system to track the real-time geographic positions of registered users relative to predefined store geofence boundaries stored in the store geofence database 104.

At decision step 304, the method 300 determines whether a user has entered a participating store geofence. The geofence detection module 202 compares the location data received from each user computing device against the predefined geofence boundaries stored in the store geofence database 216 to determine whether the geographic coordinates of a user computing device fall within a predefined store geofence boundary 132. If the user has not entered a participating store geofence, the method 300 returns to step 302 to continue monitoring location data. If the user has entered a participating store geofence, the method 300 proceeds to step 306.

At step 306, the method 300 identifies the designated neighbors of the user who entered the store geofence. The application server queries the neighbor registry database 218 via the neighbor registry module 204 to retrieve the set of designated neighbors associated with the user, where the designated neighbors are determined based on proximity of registered home addresses within a predefined geographic radius. The designated neighbor identification at step 306 is based solely on the proximity of registered home addresses and is independent of the current physical locations of the designated neighbors.

At step 308, the method 300 transmits a shopping availability notification to the user computing devices associated with the identified designated neighbors. The notification module 206 generates the shopping availability notification, which identifies the participating retail store location at which the user is present and offers the designated neighbors an opportunity to submit requests. The notification may be delivered as a push notification, an in-app alert, or any other suitable notification mechanism. The notification module 206 applies any applicable blocking preferences before transmitting the notification.

At decision step 310, the method 300 determines whether a request has been received from a designated neighbor. If no request is received, the method 300 proceeds to step 322, which represents an end or continue monitoring state in which the application server continues monitoring location data and awaits further events. If a request is received from a designated neighbor, the method 300 proceeds to step 312.

At step 312, the method 300 presents the request to the shopper via the interactive request management interface rendered on the shopper's user computing device. The request management module 208 receives the request specifying one or more requested items and displays the request to the shopper through the interactive request management interface, which provides controls enabling the shopper to accept or decline the request.

At decision step 314, the method 300 determines whether the shopper accepts the request. If the shopper declines the request, the method 300 proceeds to step 322, the end or continue monitoring state. If the shopper accepts the request, the method 300 proceeds to step 316.

At step 316, the method 300 establishes an in-app communication channel between the shopper and the designated neighbor who submitted the request. The communication module 212 creates a unique communication channel that supports text-based messaging, image sharing, and other forms of real-time communication, enabling the designated neighbor to clarify item details, specify preferences, approve substitutions, or provide additional instructions to the shopper while the shopper is at the store.

At step 318, the method 300 fulfills the request and processes a payment transaction. The shopper collects the requested items at the participating retail store location, and upon completion, the payment processing module 214 processes a secure payment transaction between the requesting neighbor and the shopper. The payment transaction may include the cost of the one or more requested items, a service fee payable to the shopper, and a platform commission retained by the application server.

At step 320, the method 300 updates roles and continues monitoring. The role-switching module 210 updates the role designations of the users involved in the transaction and the application server continues monitoring location data for subsequent geofence entry events, enabling the dynamic role-switching mechanism whereby any user may transition between shopper and requester roles based on future store visits. The method 300 then returns to step 302 to continue the monitoring cycle or may proceed to step 322 to end the current workflow instance.

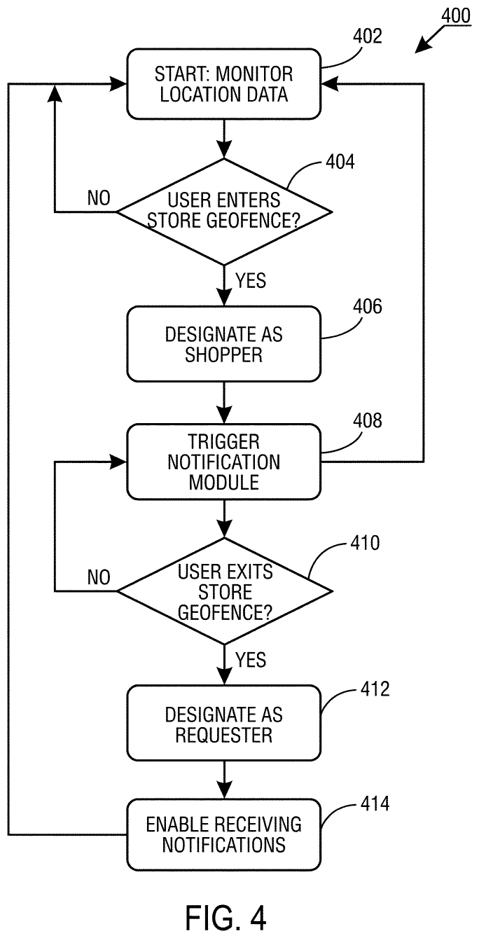

FIG. 4 illustrates a flowchart of a method 400 for dynamic role-switching between shopper and requester designations based on store geofence entry and exit detection, according to some embodiments. The method 400 may be performed by the role-switching module 210 in cooperation with the geofence detection module 202 and the notification module 206 of the application program 201 executing on the application server 200.

The method 400 begins at step 402, in which the system starts monitoring location data received from the location-tracking modules 124 of user computing devices. The application server continuously or periodically receives location data and compares it against the predefined store geofence boundaries stored in the store geofence database 216.

At decision step 404, the method 400 determines whether a user has entered a store geofence. The geofence detection module 202 evaluates the location data to determine whether the geographic coordinates of a user computing device fall within any predefined store geofence boundary. If the user has not entered a store geofence, the method 400 returns to step 402 to continue monitoring. If the user has entered a store geofence, the method 400 proceeds to step 406.

At step 406, the method 400 designates the user as a shopper. The role-switching module 210 automatically updates the role assignment of the user from a requester role or a neutral state to a shopper role in response to the geofence entry event detected at step 404. This designation occurs automatically without requiring the user to manually select or toggle their role. The shopper designation indicates that the user is currently at a participating retail store location and is available to fulfill requests from designated neighbors.

At step 408, the method 400 triggers the notification module. The role-switching module 210 signals the notification module 206 to initiate the notification workflow, causing the notification module 206 to query the neighbor registry database 218 for the set of designated neighbors of the newly designated shopper and to transmit shopping availability notifications to the user computing devices of those designated neighbors, as described in connection with FIG. 3.

At decision step 410, the method 400 determines whether the user has exited the store geofence. The geofence detection module 202 continues monitoring the location data of the user and evaluates whether the user's geographic coordinates have moved outside the predefined store geofence boundary. If the user has not exited the store geofence, the method 400 continues to monitor at step 410. If the user has exited the store geofence, the method 400 proceeds to step 412.

At step 412, the method 400 designates the user as a requester. The role-switching module 210 automatically transitions the user's role assignment from a shopper role to a requester role in response to the geofence exit event detected at step 410. The requester designation indicates that the user is no longer at a participating retail store location and is eligible to receive shopping availability notifications from other designated neighbors who subsequently enter a store geofence.

At step 414, the method 400 enables the user to receive notifications. With the user now designated as a requester, the system enables the user's computing device to receive shopping availability notifications generated by the notification module 206 when other designated neighbors enter participating store geofences. The method 400 then returns to step 402 to continue monitoring location data, thereby maintaining a continuous cycle of role-switching that automatically adapts to each user's real-time proximity to participating retail store locations.

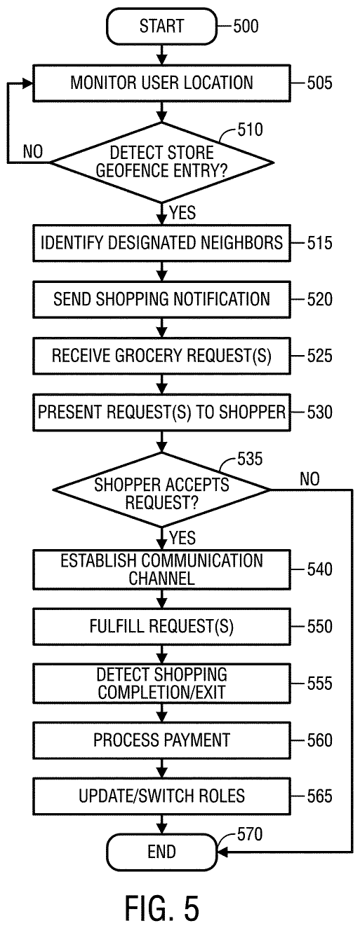

FIG. 5 illustrates a flowchart of a method 500 for the end-to-end shopping assistance workflow, according to some embodiments. The method 500 provides an alternative representation of the complete workflow from location monitoring through role updating and may be performed by the application program 201 executing on the application server 200 in cooperation with the application programs 122 executing on user computing devices.

The method 500 begins at a start step 500 and proceeds to step 505, in which the system monitors the location of registered users. The application server receives location data from the location-tracking modules 124 of user computing devices via the network 110 and evaluates the location data against the predefined store geofence boundaries stored in the store geofence database 216.

At decision step 510, the method 500 determines whether a store geofence entry has been detected. The geofence detection module 202 evaluates whether the location data indicates that a user computing device has entered a predefined store geofence boundary associated with a participating retail store location. If no geofence entry is detected, the method 500 returns to step 505 to continue monitoring. If a geofence entry is detected, the method 500 proceeds to step 515.

At step 515, the method 500 identifies the designated neighbors of the user whose geofence entry was detected. The neighbor registry module 204 queries the neighbor registry database 218 to retrieve the set of designated neighbors associated with the user, where the designated neighbors are determined based on the proximity of registered home addresses within a predefined geographic radius.

At step 520, the method 500 sends a shopping availability notification to the user computing devices associated with the identified designated neighbors. The notification module 206 generates and transmits the notification, which identifies the participating retail store location and offers the designated neighbors an opportunity to submit requests.

At step 525, the method 500 receives one or more requests from designated neighbors who wish to have items purchased on their behalf. Each request specifies one or more requested items and may include item descriptions, quantities, preferred brands, and acceptable substitutions.

At step 530, the method 500 presents the received request or requests to the shopper via the interactive request management interface rendered on the shopper's user computing device. The request management module 208 displays the requests and provides controls for the shopper to review, accept, or decline each request.

At decision step 535, the method 500 determines whether the shopper accepts the request. If the shopper does not accept the request, the method 500 may return to step 505 to continue monitoring or may end the current workflow instance. If the shopper accepts the request, the method 500 proceeds to step 540.

At step 540, the method 500 establishes an in-app communication channel between the shopper and the requesting neighbor. The communication module 212 creates the communication channel to facilitate real-time coordination regarding the requested items.

At step 550, the method 500 fulfills the request. The shopper collects the one or more requested items at the participating retail store location, and the request management module 208 tracks the fulfillment status of each requested item in real time.

At step 555, the method 500 detects shopping completion or store exit. The geofence detection module 202 detects that the shopper has exited the predefined store geofence boundary, or the shopper manually indicates that shopping is complete through the application program 122. This detection triggers the subsequent payment and role-updating steps.

At step 560, the method 500 processes a payment transaction. The payment processing module 214 processes a secure payment transaction between the requesting neighbor and the shopper, including the cost of the one or more requested items, a service fee payable to the shopper, and a platform commission retained by the application server.

At step 565, the method 500 updates and switches roles. The role-switching module 210 updates the role designations of the users, transitioning the shopper from a shopper designation to a requester designation now that the shopper has exited the store geofence, and maintaining the readiness of all users for future role transitions based on subsequent geofence entry events.

At step 570, the method 500 reaches an end step, concluding the current instance of the shopping assistance workflow. The application server continues to monitor location data as described at step 505, maintaining a continuous cycle that enables subsequent shopping sessions and role transitions for all registered users.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A system for location-based neighbor-to-neighbor shopping assistance, the system comprising:
at least one user computing device in operable connection with a network, the at least one user computing device comprising a location-tracking module configured to determine a geographic position of the at least one user computing device;
an application server in operable communication with the at least one user computing device via the network, the application server configured to host an application program for coordinating shopping between users, the application program in operable communication with one or more processors coupled to a memory, wherein the one or more processors are configured to:
maintain a store geofence database storing predefined geofence boundaries associated with one or more participating retail store locations;
maintain a neighbor registry database associating each registered user with a registered home address and identifying, for each registered user, a set of designated neighbors determined based on proximity of the respective registered home addresses within a predefined geographic radius;
receive location data from the location-tracking module of the at least one user computing device and determine, based on the received location data and the store geofence database, that a first user has entered a predefined store geofence associated with a participating retail store location;
in response to determining that the first user has entered the predefined store geofence, automatically transmit a shopping availability notification to one or more user computing devices associated with the set of designated neighbors of the first user, wherein the shopping availability notification identifies the participating retail store location and offers the designated neighbors an opportunity to submit requests;
receive, from at least one designated neighbor, a request specifying one or more requested items, and present the request to the first user via an interactive request management interface on the user computing device of the first user, the interactive request management interface enabling the first user to accept or decline each request;
upon acceptance of a request by the first user, establish an in-app communication channel between the first user and the at least one designated neighbor to facilitate real-time coordination regarding the one or more requested items; and
dynamically switch role assignments for each user between a shopper role and a requester role based on real-time location data, such that a user designated as a requester in a first transaction is automatically designated as a shopper in a subsequent transaction upon the system detecting that the user has entered a predefined store geofence.

2. The system of claim 1, wherein the predefined geographic radius used to determine the set of designated neighbors is based on proximity of registered home addresses and is independent of a current physical location of any user, such that when the first user visits a participating retail store location remote from the first user's registered home address, only the designated neighbors associated with the first user's registered home address receive the shopping availability notification.

3. The system of claim 1, wherein the one or more processors are further configured to process secure payment transactions between the at least one designated neighbor and the first user for completed requests, including calculating a service fee payable to the first user and a platform commission allocated to the application server.

4. The system of claim 1, wherein the one or more processors are further configured to support a scheduled shopping mode, wherein a user manually selects a participating retail store location and an estimated arrival time, and the system transmits a pre-arrival shopping availability notification to the set of designated neighbors of the user in advance of the estimated arrival time.

5. The system of claim 1, wherein the one or more processors are further configured to optimize request grouping by aggregating multiple requests from a plurality of designated neighbors into a consolidated task list presented to the first user, the consolidated task list organized to minimize redundant item retrieval within the participating retail store location.

6. The system of claim 1, wherein the location-tracking module implements selective location tracking that activates detailed position monitoring only when the at least one user computing device is detected within or proximate to a predefined store geofence, and reduces location-tracking frequency when the at least one user computing device is outside all predefined store geofences, thereby conserving battery power and reducing server load.

7. The system of claim 1, wherein the interactive request management interface further provides a blocking feature enabling a designated neighbor to block notifications from a specific shopper, a specific retail store location, or an entire retail store chain.

8. A computer-implemented method for location-based neighbor-to-neighbor shopping assistance, the method comprising:
registering, by an application server, a plurality of users, each user associated with a registered home address and a user computing device having a location-tracking module;
determining, by the application server, for each registered user, a set of designated neighbors based on proximity of the registered home addresses of the plurality of users within a predefined geographic radius;
monitoring, by the application server, location data received from the location-tracking modules of the user computing devices of the plurality of users;
detecting, by the application server, based on the monitored location data and a store geofence database storing predefined geofence boundaries for participating retail store locations, that a first user has entered a predefined store geofence associated with a first participating retail store location;
in response to detecting that the first user has entered the predefined store geofence, automatically transmitting, by the application server, a shopping availability notification to user computing devices associated with the set of designated neighbors of the first user, the shopping availability notification identifying the first participating retail store location;
receiving, by the application server from a second user who is a designated neighbor of the first user, a request specifying one or more requested items;
presenting, by the application server, the request to the first user via an interactive request management interface on the user computing device of the first user;
receiving, by the application server, an acceptance of the request from the first user;
establishing, by the application server, an in-app communication channel between the first user and the second user to facilitate coordination regarding the one or more requested items; and
automatically switching, by the application server, role assignments for the first user and the second user, such that the second user is designated as a shopper when the application server detects that the second user has subsequently entered a predefined store geofence associated with a participating retail store location, and the first user is designated as a potential requester eligible to receive a shopping availability notification from the second user.

9. The method of claim 8, further comprising: upon acceptance of the request, adding the one or more requested items to a shopper task list displayed on the user computing device of the first user, and tracking fulfillment status of each requested item in real time.

10. The method of claim 8, further comprising: processing, by the application server, a secure payment transaction between the second user and the first user upon completion of the request, the secure payment transaction comprising a cost of the one or more requested items, a service fee payable to the first user, and a platform commission retained by the application server.

11. The method of claim 8, wherein detecting that the first user has entered the predefined store geofence comprises comparing the location data from the location-tracking module of the user computing device of the first user against the predefined geofence boundaries stored in the store geofence database, and confirming entry when the location data indicates the first user is within the predefined geofence boundary for a threshold duration.

12. The method of claim 8, wherein the shopping availability notification is transmitted exclusively to user computing devices associated with designated neighbors determined based on proximity of registered home addresses, such that users who are physically proximate to the first participating retail store location but are not designated neighbors of the first user based on registered home address proximity do not receive the shopping availability notification.

13. The method of claim 8, further comprising: receiving, by the application server from the first user, a scheduled shopping indication specifying a selected participating retail store location and an estimated arrival time; and transmitting, by the application server, a pre-arrival shopping availability notification to user computing devices associated with the set of designated neighbors of the first user in advance of the estimated arrival time, the pre-arrival shopping availability notification identifying the selected participating retail store location and the estimated arrival time.

14. The method of claim 8, further comprising: aggregating, by the application server, a plurality of requests received from a plurality of designated neighbors of the first user into a consolidated task list; and presenting the consolidated task list to the first user via the interactive request management interface, the consolidated task list organized to group requested items for efficient retrieval.

15. A non-transitory computer-readable storage medium storing computer-executable instructions that, when executed by one or more processors of a computing system, cause the computing system to perform operations comprising:
maintaining a store geofence database comprising predefined geofence boundaries associated with a plurality of participating retail store locations;
maintaining a neighbor registry database associating each of a plurality of registered users with a registered home address and identifying, for each registered user, a set of designated neighbors determined based on proximity of the respective registered home addresses within a predefined geographic radius;
receiving location data from location-tracking modules of user computing devices associated with the plurality of registered users;
determining, based on the received location data and the store geofence database, that a first registered user has entered a predefined store geofence associated with a first participating retail store location;
in response to determining that the first registered user has entered the predefined store geofence, automatically generating and transmitting a shopping availability notification to user computing devices associated with the set of designated neighbors of the first registered user;
receiving a request from a second registered user who is a designated neighbor of the first registered user, the request specifying one or more requested items;
presenting the request to the first registered user via an interactive request management interface and receiving an acceptance or declination of the request from the first registered user;
upon acceptance, establishing an in-app communication channel between the first registered user and the second registered user; and
dynamically switching role designations between a shopper role and a requester role for each of the plurality of registered users based on real-time location data, wherein the role designations are automatically updated when the computing system detects that a registered user has entered a predefined store geofence.

16. The non-transitory computer-readable storage medium of claim 15, wherein the operations further comprise: implementing selective location tracking that activates high-frequency position monitoring for a user computing device only when the user computing device is detected within or proximate to a predefined store geofence and reduces position monitoring frequency when the user computing device is outside all predefined store geofences.

17. The non-transitory computer-readable storage medium of claim 15, wherein the operations further comprise: processing a secure payment transaction between the second registered user and the first registered user, the secure payment transaction comprising a cost of the one or more requested items, a service fee payable to the first registered user for fulfilling the request, and a platform commission.

18. The non-transitory computer-readable storage medium of claim 15, wherein the set of designated neighbors is determined solely based on proximity of registered home addresses within the predefined geographic radius, independent of a current physical location of any registered user, such that a registered user visiting a participating retail store location in a geographic area different from the registered user's registered home address triggers notifications only to the designated neighbors associated with the registered user's registered home address.

19. The non-transitory computer-readable storage medium of claim 15, wherein the operations further comprise: receiving from the first registered user a scheduled shopping indication specifying a selected participating retail store location and an estimated arrival time, and transmitting a pre-arrival shopping availability notification to user computing devices associated with the set of designated neighbors prior to the estimated arrival time.

20. The non-transitory computer-readable storage medium of claim 15, wherein the interactive request management interface further provides a blocking mechanism enabling a designated neighbor to selectively suppress notifications originating from a specified shopper, a specified retail store location, or a specified retail store chain.
